(19) United States
(12) Patent Application Publication
(10) Pub. No.: US 2026/0349285 A1
(43) Pub. Date: Nov. 5, 2026

(54) Augmented Reality Display

(71) Applicant: Sensor Electronic Technology, Inc., Columbia, SC (US)

(72) Inventor: Piyush Sharma, Columbia, SC (US)

(21) Appl. No.: 19/665,084

(22) Filed: May 1, 2026

Related U.S. Application Data
(60) Provisional application No. 63/798,217, filed on May 1, 2025.

(51) Int. Cl. G02F 1/01; G02B 27/01; G02C 7/10

(52) U.S. Cl. CPC G02F 1/0126; G02B 27/0172; G02C 7/102; G02B 2027/0178

(57) ABSTRACT

An augmented reality system includes a display substrate for presenting augmented reality content to a user. The display substrate can include a transparent substrate which includes one or more areas on which the augmented reality content can be displayed. A photo-reactive coating can be applied to at least a portion of a surface of the transparent substrate, which corresponds to the area(s) on which the augmented reality content can be displayed during use of the augmented reality system.

### REFERENCE TO RELATED APPLICATIONS

The current application claims the benefit of U.S. Provisional Application 63/798,217, filed on 1 May 2025, which is hereby incorporated by reference.

### TECHNICAL FIELD

The disclosure relates generally to wearable devices, and more particularly, to wearable devices including augmented reality displays.

### BACKGROUND ART

Augmented Reality (AR) displays are widely used in various wearable devices including smart glasses, heads-up displays (HUDs), and the like. The AR displays for these devices rely on technologies such as OLED micro-displays, waveguide optics, and projection-based solutions to overlay digital images onto real-world environments. However, under high ambient light conditions, such as in direct sunlight or high glare environments, current AR displays suffer from low contrast and reduced readability.

OLED micro-displays are self-emissive screens that produce high-contrast images but struggle with visibility in bright conditions because the emitted light competes with strong ambient light. Waveguide optics direct light from a micro-display into a thin, transparent lens, allowing AR images to appear “floating” in front of the user. However, the resulting AR images often suffer from low contrast when exposed to sunlight. Projection-based solutions project digital images directly onto lenses, but their brightness is limited, leading to poor readability in outdoor environments.

To counter these limitations, current AR displays increase brightness. However, the increased power leads to higher power consumption and battery drain. For example, OLED displays with higher brightness drastically increase power consumption. Furthermore, these displays do not selectively enhance the AR elements, but increase the brightness of the entire display.

External counter measures include polarized or tinted lenses and electrochromic coatings. However, these approaches also require continuous power to function. Electrochromic lenses can adapt their transparency, but have response times in the range of seconds, making them unsuitable for real-time contrast enhancement. Additionally, these lenses alter the entire field of vision, which affects the user experience. Polarized or tinted lenses reduce visibility in low light conditions, making the AR elements more difficult to see and also do not dynamically adapt to changing environments.

### SUMMARY OF THE INVENTION

Aspects of the invention provide an augmented reality system, which provides an improved solution for enhancing augmented reality content displayed to a user. The augmented reality display can include a photo-reactive coating that can be activated using ultraviolet radiation in order to adjust one or more of its properties. The adjusted properties can result in increased contrast for the augmented reality content, thereby improving visibility of the content in high ambient light conditions. Use of ultraviolet light sources and the photo-reactive coating can provide a solution with a fast response time and without significant power requirements. The photo-reactive coating can be selectively activated in locations corresponding to the augmented reality content, leaving the remaining augmented reality display area with a natural view.

Embodiments can outperform previous approaches by providing a fast, low-power, and adaptive contrast enhancement mechanism that selectively improves augmented reality display visibility only where needed, rather than dimming or modifying the entire display. Unlike electrochromic or OLED-based approaches, embodiments can achieve high contrast while keeping power consumption minimal, making augmented reality displays more practical for use in outdoor and high-light environments.

Aspects of the invention provide an augmented reality system including a display substrate for presenting augmented reality content to a user. The display substrate can include a transparent substrate which includes one or more areas on which the augmented reality content can be displayed. A photo-reactive coating can be applied to at least a portion of a surface of the transparent substrate, which corresponds to the area(s) on which the augmented reality content can be displayed during use of the augmented reality system.

A first aspect of the invention provides an augmented reality system comprising: a display substrate including: a transparent substrate; and a photo-reactive coating applied to at least a portion of a surface of the transparent substrate, wherein the at least the portion of the surface corresponds to an area on which augmented reality content can be displayed during use of the augmented reality system.

A second aspect of the invention provides a wearable device comprising: an augmented reality control system configured to present augmented reality content to a user wearing the wearable device; and a transparent display substrate including: a transparent substrate through which the user can view an environment and on which augmented reality content can be displayed; and a photo-reactive coating applied to only a portion of an outer facing surface of the transparent substrate, wherein the portion of the outer facing surface corresponds to an area of the transparent substrate on which the augmented reality content can be displayed.

A third aspect of the invention provides an augmented reality system comprising: an augmented reality control system configured to present augmented reality content to a user; a display substrate including: a transparent substrate; and a photo-reactive coating applied to at least a portion of a surface of the transparent substrate, wherein the at least the portion of the surface corresponds to an area on which augmented reality content can be displayed during use of the augmented reality system; at least one light sensor configured to acquire ambient lighting data regarding ambient lighting for an environment in which the display substrate is located; and at least one ultraviolet light source configured to emit ultraviolet radiation directed onto at least one region of the photo-reactive coating from at least one location on the frame based on the ambient lighting data.

The illustrative aspects of the invention are designed to solve one or more of the problems herein described and/or one or more other problems not discussed.

### BRIEF DESCRIPTION OF THE DRAWINGS

These and other features of the disclosure will be more readily understood from the following detailed description of the various aspects of the invention taken in conjunction with the accompanying drawings that depict various aspects of the invention.

FIG. 1 shows an illustrative augmented reality view adversely affected by glare according to the prior art.

FIG. 2 shows an illustrative augmented reality display device according to embodiments.

FIG. 3 shows an exploded view of an illustrative augmented reality display substrate according to embodiments.

FIG. 4 shows a cutaway view of an illustrative frame securing an augmented reality display substrate according to embodiments.

FIG. 5 shows a cutaway view of an illustrative ultraviolet source illuminating an augmented reality display substrate according to embodiments.

FIG. 6 shows an illustrative augmented reality display device configured to enhance individual regions of the display substrate according to embodiments.

FIG. 7 shows a schematic of an illustrative augmented reality system according to embodiments.

FIG. 8 shows an illustrative process for adjusting attributes of an augmented reality transparent substrate according to embodiments.

It is noted that the drawings may not be to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, aspects of the invention provide an augmented reality display system, such as a wearable augmented reality display device. In embodiments, the wearable augmented reality display device can comprise glasses, a headset, a monocle, a helmet, goggles, and/or the like. In other embodiments, the augmented reality display system may be implemented on a device other than a wearable device. For example, embodiments of the augmented reality display system can be implemented on a windshield or window of a vehicle, a mirror of a vehicle, and/or the like.

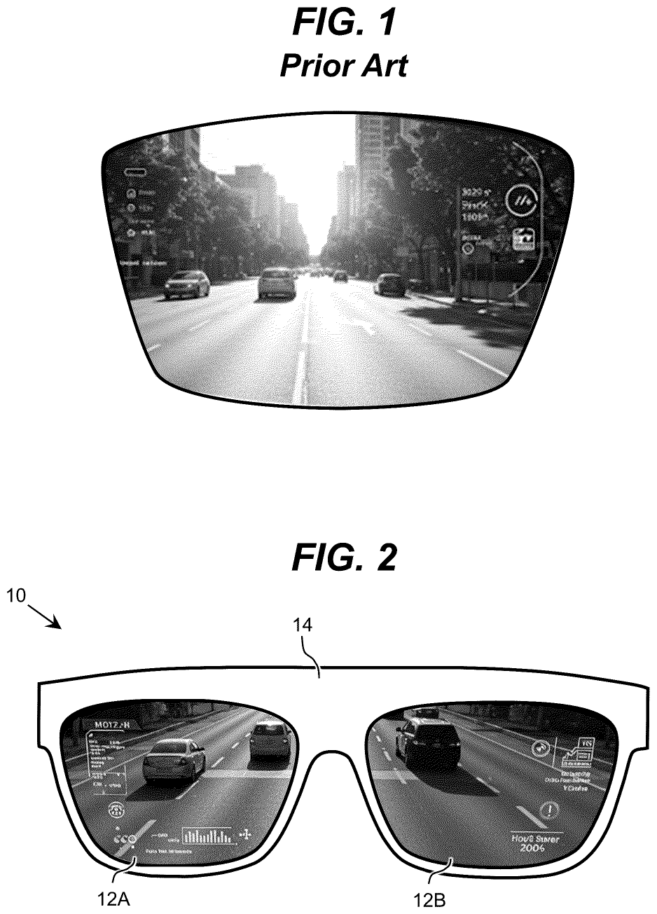

As described herein, current augmented reality display devices suffer from poor contrast in certain lighting conditions, making the augmented reality content difficult for the user to discern. For example, FIG. 1 shows an illustrative augmented reality view adversely affected by glare according to the prior art. As illustrated, the bright sunlight in the environment causes glare and reduced contrast for the augmented reality content being presented to the user.

FIG. 2 shows an illustrative augmented reality (AR) display device 10 according to embodiments. In this case, the AR display device 10 comprises glasses. However, it is understood that this is only illustrative of various types of AR display devices according to embodiments.

The AR display device 10 is shown including a pair of AR display substrates 12A, 12B through which a user can see and on which AR data can be displayed. Each AR display substrate 12A, 12B can be secured in place by a frame 14. The frame 14 can be configured to hold the AR display device 10 in place in front of a user's eyes using any solution. For example, the frame 14 can be configured to be secured to a pair of glasses used by the user. Alternatively, the frame 14 can be configured to be placed on a user's head using any solution, such as via a pair of temples, which can be located on opposing sides of the frame 14.

As is known, an AR display device 10 can comprise various components for sensing the environment and presenting information to the user. To this extent, while not illustrated in FIG. 2, embodiments of the AR display device 10 can include various sensing devices for acquiring information for use in generating information for presentation to the user. Such sensing devices can include a camera, a microphone, a geolocation device (e.g., a GPS receiver), and/or the like. Additionally, embodiments of the AR display device 10 can include various output devices, such as a speaker, an AR content display component (e.g., an OLED micro-display, waveguide optics, a projection-based display, etc.), and/or the like. Embodiments of the AR display device 10 also can include a power component (e.g., a rechargeable battery) and a computer system which is configured to operate and acquire environment data from the various sensing device(s), process the environment data to generate AR output data, and operate the various output devices to present the AR output data to the user. The various components, as well as wiring and connectivity between the various components can be embedded within the frame 14, temples, and/or the like.

Embodiments of the AR display device 10 can be configured to ensure a minimum contrast for the AR content displayed on one or both of the AR display substrates 12A, 12B. In embodiments, the AR display device 10 includes an ultraviolet radiation-based solution for adaptively and/or selectively improving attributes of an AR display substrate, e.g., in response to environment having a bright source of light, which can cause glare on one or both of the AR display substrates 12A, 12B.

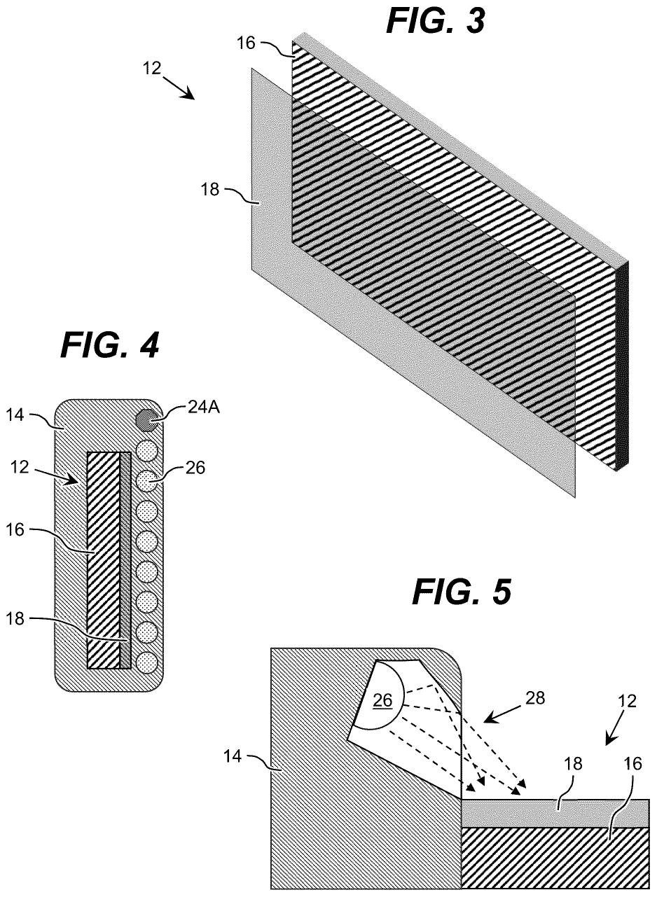

FIG. 3 shows an exploded view of an illustrative augmented reality (AR) display substrate 12 according to embodiments. As illustrated, the AR display substrate 12 comprises a transparent substrate 16 on which the AR content is displayed. In embodiments, the transparent substrate 16 is formed of glass. In more particular embodiments, the transparent substrate 16 can comprise a lens. In embodiments, the transparent substrate 16 can comprise a multi-layer structure. For example, embodiments of the transparent substrate 16 can comprise a waveguide, which is configured to direct AR output data for display at a desired location via total internal reflection (TIR). While not shown, embodiments of the AR display substrate 12 can include a reflective backing (e.g., silver) applied to the transparent substrate 16, which makes the AR display substrate 12 reflective.

Furthermore, the AR display substrate 12 comprises a photo-reactive coating 18. In embodiments, the photo-reactive coating 18 is applied to an outer facing surface of the AR display substrate 12, e.g., the surface that is located furthest away from the user when the AR display device 10 (FIG. 2) is properly worn by the user. The photo-reactive coating 18 can be applied using any suitable solution, including, for example, physical vapor deposition (PVD), chemical vapor deposition (CVD), spin coating (e.g., which can provide a uniform application of sol-gel, polymer-based coatings, and the like), spray coating or dip-coating (e.g., which can be selected based on the substrate geometry), nanoimprint lithography, and/or the like. While illustrated as being applied to substantially all of a surface of the transparent substrate 16, it is understood that embodiments of the photo-reactive coating 18 can be applied to only one or more regions of the surface of the transparent substrate 16, e.g., the region(s) corresponding to the areas on which the AR content is displayed.

The photo-reactive coating 18 is configured to be activated by ultraviolet light. When activated, the photo-reactive coating 18 dynamically modifies one or more of its optical properties, such as transparency, reflectivity, color absorption, and/or the like. In embodiments, the photo-reactive coating 18 darkens when activated by the ultraviolet light. In this manner, a visibility of the AR content can be improved, e.g., by reducing reflections from external light source(s) which may impede the user's ability to view the AR content. In embodiments, the effect of the ultraviolet light on the activated region of the photo-reactive coating 18 gradually reduces over time without an additional activation by the ultraviolet light.

Activation of the photo-reactive coating 18 can be triggered by exposure to ultraviolet radiation, which may span any suitable portion of the UV spectrum (e.g., UV-A, UV-B, or UV-C), depending on the specific photo-reactive coating 18 employed. The radiation dose required for activation is generally low, e.g., typically in a range of approximately 0.1 to approximately 1.0 mJ/cm², and can typically be achieved under high ambient outdoor lighting conditions. However, in scenarios where natural ultraviolet exposure is insufficient, such as indoor use, nighttime use, shaded environments, etc., artificial enhancement through integrated UV light sources may be utilized to ensure reliable and uniform activation. Once activated, the photo-reactive coating 18 can dynamically modify one or more optical properties, such as darkening, changing reflectance, or altering spectral transmission characteristics, to enhance visibility and contrast of augmented content. The activation response time may range from milliseconds to seconds, depending on the material, and the photo-reactive coating 18 can naturally revert to its original optical state over a period of seconds to minutes following cessation of UV exposure.

Embodiments of the photo-reactive coating 18 comprise a nanostructured coating having photochromic and/or photonic properties. Such a coating can provide a fast (e.g., on the order of milliseconds) switching response when activated by ultraviolet light. The nanostructured coating may be composed of engineered materials such as photonic crystals, plasmonic nanoparticles (e.g., silver, gold, etc.), nano-dispersed photochromic compounds, like spiropyrans, fulgides, and/or diarylethenes, embedded in a transparent polymer matrix, and/or the like. These nanostructures can manipulate light through optical interference, resonance, or refractive index modulation, enabling fast, reversible changes in optical properties such as contrast and reflectivity when exposed to ultraviolet light. Embodiments of these coatings can be designed to be lightweight, transparent when inactive, and can be compatible with common AR lens materials. Such coatings can be fabricated using known methods, such as nanoimprint lithography, layer-by-layer deposition, etc.

In other embodiments, the photo-reactive coating 18 can comprise a photochromic coating. Such a coating can comprise, for example, silver halide, which has a slower (e.g., on the order of seconds) switching response when activated by ultraviolet light. Regardless, the photo-reactive coating 18 can be configured to alter one or more of its optical properties upon exposure to ultraviolet radiation.

In embodiments, the photo-reactive coating 18 can be configured to darken (e.g., allow less visible light to pass therethrough) in response to the ultraviolet radiation, thereby enabling visibility of the AR content to be improved. Coatings that can darken in response to ultraviolet radiation include photochromic materials such as spiropyrans, fulgides, or silver halide compounds, as well as photonic or plasmonic nanostructured films that alter their optical transmission properties under UV exposure. These coatings can be activated by various types of ultraviolet light, depending on the material composition. In general, the required dose can be low, e.g., typically in a range of approximately 0.1 to approximately 0.5 mJ/cm², which can be provided by strong ambient sunlight and/or provided or supplemented by integrated ultraviolet light sources, if needed.

In embodiments, the photo-reactive coating 18 can have refractive index properties that are altered upon ultraviolet radiation exposure. In embodiments, the altered refractive index properties result in a reflectivity that is lowered, thereby reducing glare for the user. Photo-reactive coatings that can alter their refractive index upon exposure to ultraviolet radiation include nanostructured photonic crystals, liquid crystal-based photo-responsive polymers, hybrid materials incorporating photo-switchable moieties such as azobenzenes or spiropyrans, and/or the like. These materials can be engineered to exhibit an ultraviolet-triggered shift in refractive index, which in turn modifies surface reflectivity and optical impedance—thereby reducing glare and improving AR content visibility. These coatings are typically responsive to a range of ultraviolet wavelengths (UV-A to UV-C), depending on the material composition. The dose required for activation is low, generally in the range of approximately 0.1 to approximately 1.0 mJ/cm². This dose can be supplied under high ambient sunlight or through integrated UV LEDs when needed for consistent performance. In embodiments, the effect is directional, preventing light washout without dimming the entire display.

In embodiments, the photo-reactive coating can fluoresce in response to exposure to ultraviolet radiation, which can result in a brightness of the AR content being increased. Illustrative suitable fluorescent coatings include materials doped with rare-earth ions (e.g., europium, terbium, and/or the like), quantum dots, organic fluorophores such as coumarins or rhodamines, and/or the like. These materials absorb ultraviolet radiation and re-emit visible light, thereby increasing perceived brightness or contrast in the AR field of view. Such fluorescent coatings typically respond to UV-A or UV-B light, though broader-spectrum UV sensitivity can be engineered. The activation dose is generally low, around approximately 0.1 to approximately 0.3 mJ/cm², and is achievable under natural sunlight or through controlled exposure from integrated low-power UV light sources.

In embodiments, the AR display device is configured such that one or more regions of the surface of the photo-reactive coating 18 can be individually activated. For example, in embodiments, only region(s) corresponding to areas on the AR display substrate 12 on which AR content is currently displayed are activated. In this manner, the visibility of the AR content can be improved without affecting the entire area being viewed by the user. In embodiments, once activated the photo-reactive coating 18 will maintain the modified attribute(s) for a period of time. In this case, the ultraviolet radiation sources can be operated intermittently, e.g., only when the photo-reactive coating 18 must be reactivated.

FIG. 4 shows a cutaway view of an illustrative frame 14 securing an augmented reality (AR) display substrate 12 according to embodiments. As illustrated, an end of the AR display substrate 12 can be configured to be inserted into the frame 14 and secured therein using any suitable solution (e.g., transition fit, glue, and/or the like). Regardless, the frame 14 can include one or more sensing devices located therein. In embodiments, a sensing device can comprise a light sensor 24A configured to acquire data regarding a brightness of an ambient environment in which the corresponding AR display system is being utilized. In embodiments, the light sensor 24A is located at an outer facing location on the frame 14 near the display substrate 12. For example, the light sensor 24A can be located in a central portion of AR glasses located above the user's nose. In embodiments, the frame 14 can include multiple light sensors 24A, which can be located at various locations on the frame 14. In embodiments, the data acquired by each light sensor 24A can be used to determine a likely brightness for a corresponding region of the AR display substrate 12 located adjacent thereto. In embodiments, a light sensor 24A can acquire data corresponding to an intensity of only a certain type of radiation, such as only visible light, only a type of ultraviolet radiation, and/or the like. To this extent, embodiments of the frame 14 can include multiple light sensors 24A, each of which provides data corresponding to an intensity of a corresponding type of light.

The frame also is shown including a plurality of ultraviolet light sources 26. Each ultraviolet light source 26 can be configured to illuminate a corresponding region of the photo-reactive coating 18 with ultraviolet light. In embodiments, an ultraviolet light source 26 can emit ultraviolet light in the UVA and/or UVB regions of the ultraviolet spectrum. In more particular embodiments, an ultraviolet light source 26 can emit ultraviolet radiation having a peak wavelength located in a range between approximately 365 nanometers and approximately 405 nanometers. In embodiments, an ultraviolet light source 26 can comprise an ultraviolet light emitting diode, which can be mounted to/embedded within the frame 14. In other embodiments, an ultraviolet light source 26 can comprise an end of a waveguiding structure, such as an optical fiber, from which ultraviolet radiation can be emitted. Regardless, the ultraviolet light source 26 can be configured to direct ultraviolet radiation onto the corresponding region of the photo-reactive coating 18. In embodiments, the ultraviolet light sources 26 can be operated together, individually, and/or in sub-groups in order to illuminate one or more regions of the photo-reactive coating 18. In embodiments, each ultraviolet light source 26 can emit ultraviolet light of a varying intensity, which can be selected based on ambient light conditions, AR display requirements, and/or the like.

It is understood that ultraviolet light sources 26 embedded in a frame 14 are only illustrative of various possible configurations for ultraviolet light sources 26. In embodiments, the ultraviolet light sources 26 can be integrated into a waveguide structure, e.g., when the AR content is displayed using such an approach. Embodiments incorporating such a configuration can provide a more compact design. Additionally, embodiments can incorporate externally mounted ultraviolet emitters, e.g., as part of a solution for enhancing existing or third party AR displays. In these embodiments, alignment of the ultraviolet light sources 26 can be performed via the mounting solution and may require manual adjustments.

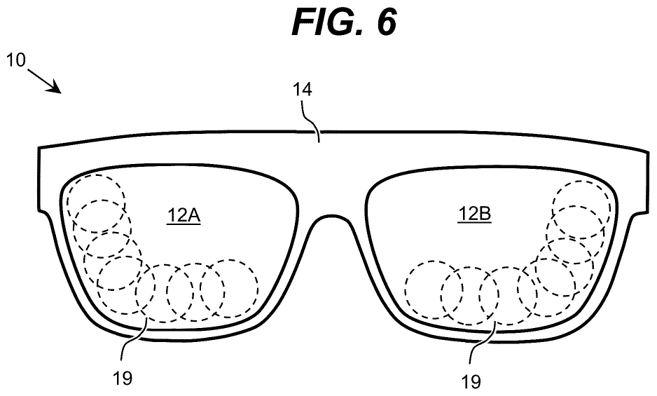

FIG. 5 shows a cutaway view of an illustrative ultraviolet source 26 illuminating an augmented reality display substrate 12 according to embodiments. As illustrated, the ultraviolet source 26 can be mounted in a recess 28 formed within the frame 14. In embodiments, the ultraviolet source 26 and/or recess 28 can be configured to direct ultraviolet light emitted by the ultraviolet source 26 downward towards the photo-reactive coating 18. Such an illumination can prevent ultraviolet light from being directed toward a user or another object.

In embodiments, most ultraviolet light, whether from ambient sources or the ultraviolet source 26, is either blocked, reflected, or internally absorbed by the augmented reality display substrate 12 materials. For example, a typical augmented reality display substrate 12 can be composed of glass or polymer layers that inherently absorb or attenuate ultraviolet radiation, particularly in the UV-B and UV-C ranges. Since embodiments of the ultraviolet source 26 can be configured to direct ultraviolet light toward the augmented reality display substrate 12 and not directly toward the user, and the augmented reality display substrate 12 naturally limits ultraviolet transmission, embodiments do not require a dedicated ultraviolet-blocking structure on the user-facing side of the augmented reality display substrate 12. In embodiments, a thickness and/or material(s) of the layers in the augmented reality display substrate 12 can be selected to ensure that no ultraviolet radiation passes therethrough.

It is understood that any of various solutions can be used to direct the ultraviolet light to only impact a defined area of the photo-reactive coating 18. For example, the solutions can include mounting the ultraviolet light source 26 at a downward angle, using one or more reflective surfaces to direct the ultraviolet light downward, using one or more surfaces to prevent the ultraviolet light from exiting the recess 28 in a direction going away from or in parallel with the photo-reactive coating 18, etc. In embodiments, the recess 28 can be filled with a transparent material to protect the corresponding ultraviolet source 26 from contamination. Illustrative materials include fused quartz, UVC silicones, clear acrylic, and/or the like. In embodiments, an external surface of the transparent material can include a shaped surface, surface roughening, and/or the like, which can be configured to further direct the ultraviolet radiation in a desired manner.

FIG. 6 shows an illustrative augmented reality (AR) display device 10 configured to enhance individual regions 19 of the AR display substrates 12A, 12B according to embodiments. In embodiments, the AR display device 10 is configured to only enhance regions 19 of the AR display substrates 12A, 12B corresponding to locations where AR content is currently being presented to the user. In embodiments, the AR display device 10 can include multiple ultraviolet sources, e.g., embedded in the frame 14 as described herein, each of which can be operated to activate a region 19. As discussed herein, the ultraviolet sources can be individually operated, operated together, and/or operated in sub-groups to activate any combination of one or more regions 19 of the AR display substrates 12A, 12B.

As illustrated, each region 19 can be elliptical, and can partially overlap with one or more other regions 19. However, it is understood that this is only illustrative of various possible configurations for regions 19. Additionally, it is understood that the number, size, and location of the regions 19 illustrated in FIG. 6 are only illustrative of various possible configurations. In embodiments, the AR display device 10 includes ultraviolet sources that can activate regions 19 that cover substantially all of the area of the AR display substrates 12A, 12B, thereby enabling substantially all of the area of the photo-reactive coating 18 to be activated, if desired.

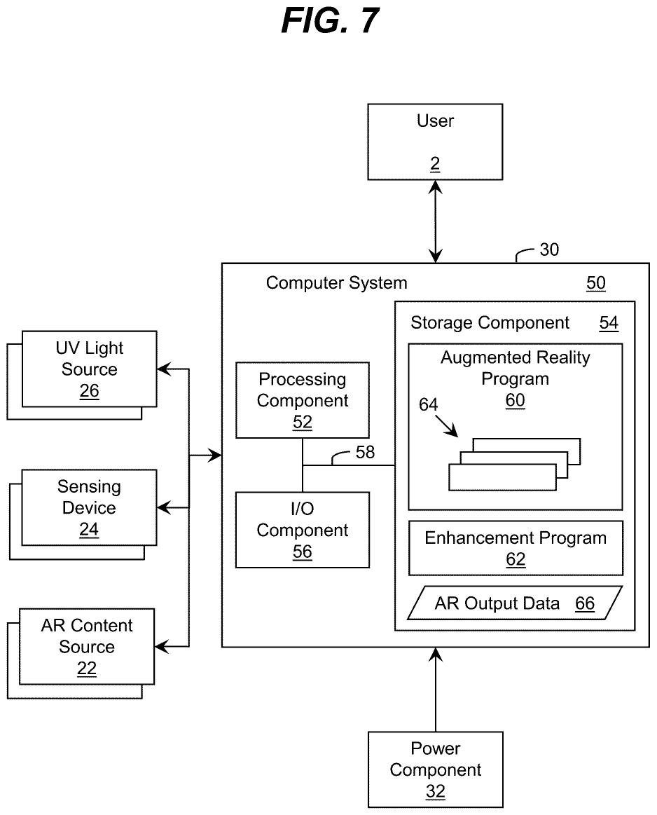

FIG. 7 shows a schematic of an illustrative augmented reality (AR) system according to embodiments. To this extent, the AR system includes a computing unit 30, which is shown implemented as a computer system 50 that can perform a process described herein in order to present AR content to a user 2. In particular, the computer system 50 is shown including an augmented reality program 60, which makes the computer system 50 operable to present AR output data 66 to the user 2 by performing a process described herein. In particular, the process can include generating and providing the AR output data 66 to an AR content source 22, such as a speaker, an AR display device, and/or the like, for presentation to the user 2. Furthermore, the computer system 50 is shown including an enhancement program 62, which makes the computer system 50 operable to enhance one or more regions of an AR display substrate by performing a process described herein.

The computer system 50 is schematically illustrated as including a processing component 52 (e.g., one or more processors), a storage component 54 (e.g., a storage hierarchy), an input/output (I/O) component 56 (e.g., one or more I/O interfaces and/or devices), and a communications pathway 58. In general, the processing component 52 executes program code, such as the augmented reality program 60 and/or the enhancement program 62, which is at least partially fixed in storage component 54. While executing program code, the processing component 52 can process data, which can result in reading and/or writing transformed data from/to the storage component 54 and/or the I/O component 56 for further processing. The pathway 58 provides a communications link between each of the components in the computer system 50.

The I/O component 56 can comprise one or more human I/O devices, which enable a human user 2 to interact with the computer system 50 and/or one or more communications devices to enable a system user 2 (e.g., a portable computing device of a human user, such as a mobile phone executing an app) to communicate with the computer system 50 using any type of communications link. To this extent, the treatment program 60 and/or illumination program 62 can manage a set of interfaces (e.g., graphical user interface(s), application program interface, and/or the like) that enable human and/or system users 2 to interact with the augmented reality program 60 and the AR output data 66, the enhancement program 62, etc. Furthermore, the treatment program 60 can manage (e.g., store, retrieve, create, manipulate, organize, present, etc.) the AR output data 64 using any solution.

In any event, the computer system 50 can comprise one or more general purpose computing articles of manufacture (e.g., computing devices) capable of executing program code, such as the augmented reality program 60 and/or enhancement program 62, installed thereon. As used herein, it is understood that “program code” means any collection of instructions, in any language, code or notation, that cause a computing device having an information processing capability to perform a particular action either directly or after any combination of the following: (a) conversion to another language, code or notation; (b) reproduction in a different material form; and/or (c) decompression. To this extent, the augmented reality program 60 can be embodied as any combination of system software and/or application software.

Furthermore, the augmented reality program 60 and/or enhancement program 62 can be implemented using a set of modules 62. In this case, a module 62 can enable the computer system 50 to perform a set of tasks used by the augmented reality program 60 and/or enhancement program 62, and can be separately developed and/or implemented apart from other portions of the augmented reality program 60 and/or enhancement program 62. As used herein, the term “component” means any configuration of hardware, with or without software, which implements the functionality described in conjunction therewith using any solution, while the term “module” means program code that enables a computer system 50 to implement the actions described in conjunction therewith using any solution. Regardless, it is understood that two or more components, modules, and/or systems may share some/all of their respective hardware and/or software. Furthermore, it is understood that some of the functionality discussed herein may not be implemented or additional functionality may be included as part of the computer system 50.

When the computer system 50 comprises multiple computing devices, each computing device can have only a portion of the augmented reality program 60 and/or enhancement program 62 fixed thereon (e.g., one or more modules 62). In embodiments, the computer system 50 can comprise a computing unit located within a frame 14 of an AR display device 10 described herein and a portable computing unit, such as a mobile phone or a vehicle computing unit, which is executing an app installed thereon for enabling a user 2 to selectively control operation of the AR display device, e.g., by defining desired content to be displayed.

However, it is understood that the computer system 50 and the augmented reality program 60 and/or enhancement program 62 are only representative of various possible equivalent computer systems that may perform a process described herein. To this extent, in other embodiments, the functionality provided by the computer system 50 and the augmented reality program 60 and/or enhancement program 62 can be at least partially implemented by one or more computing devices that include any combination of general and/or specific purpose hardware with or without program code. In each embodiment, the hardware and program code, if included, can be created using standard engineering and programming techniques, respectively.

Regardless, when the computer system 50 includes multiple computing devices, the computing devices can communicate over any type of communications link. Furthermore, while performing a process described herein, the computer system 50 can communicate with one or more other computer systems using any type of communications link. In either case, the communications link can comprise any combination of various types of optical fiber, wired, and/or wireless links; comprise any combination of one or more types of networks; and/or utilize any combination of various types of transmission techniques and protocols.

The power component 32 can comprise any type of power source. For example, the power component 32 can comprise one or more batteries, an electrical plug and transformer for obtaining power from an electrical receptacle, and/or the like. Regardless, the power component 32 can be configured to provide sufficient power to operate the remaining components of the AR system. In embodiments, the power component 32 can comprise a rechargeable battery, which can be recharged using a wireless charging solution.

As discussed herein, the computing unit 30 can receive sensor data from various sensing devices 24 and generate AR output data 66 based on the sensor data. The computing unit 30 can provide the AR output data 66 to one or more AR content sources 22 for presentation to the user 2 using any of various known solutions. In embodiments, the sensing devices 24 include one or more light sensors and the sensor data includes ambient lighting data corresponding to a brightness of an ambient environment acquired by the light sensor(s). The enhancement program 62 can process the ambient lighting data and operate one or more ultraviolet light sources 26 to activate one or more regions of an AR display substrate in order to ensure a contrast for the AR content presented thereon.

In embodiments, the ambient lighting data includes ambient brightness for both ultraviolet and visible light. In embodiments, the enhancement program 62 can be configured to only operate the one or more ultraviolet light sources 26 in response to the ambient brightness of the visible light exceeding a predetermined level while the ambient brightness of the ultraviolet light is below a predetermined level.

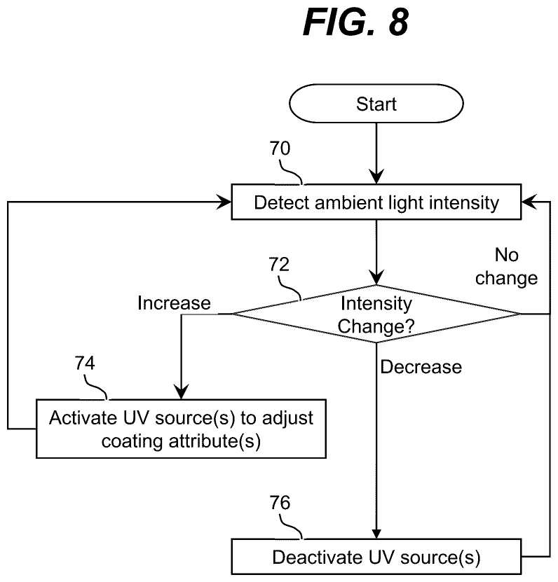

FIG. 8 shows an illustrative process for adjusting attributes of an augmented reality transparent substrate according to embodiments, which can be implemented by the AR system shown in FIG. 7.

In action 70, one or more light sensors 24 can acquire data regarding an ambient light intensity for a location at which an AR display is being utilized. In action 72, the computing unit 30 can determine whether a meaningful change in light intensity has occurred, e.g., the brightness has increased or decreased such that a contrast for AR content presented on an AR display is adversely affected (e.g., due to an increase) or is no longer significantly affected (e.g., due to a decrease).

The computing unit 30 can use any suitable solution to determine that a change is meaningful. In embodiments, an intensity going above or below a predefined threshold corresponds to a meaningful change. In embodiments, different thresholds are used to identify meaningful changes in increasing intensity and decreasing intensity. For example, a higher threshold can be used to identify a meaningful increase in intensity and a lower threshold can be used to identify a meaningful decrease in intensity. In further embodiments, one or more of the thresholds can be user-defined.

Using data acquired by one or more ambient light sensors 24, embodiments of the computing unit 30 can be adaptive and dynamically adjust operation of the ultraviolet source(s) 26 based on data corresponding to the intensity of and/or type of surrounding light. In high ambient lighting conditions with ultraviolet light (e.g., bright sunlight), the computing unit 30 can activate full contrast enhancement to ensure visibility of the AR content. In medium ambient lighting, embodiments of the computing unit can apply a moderate level of enhancement, and under low ambient lighting, embodiments of the computing unit 30 can determine that minimal or no enhancement may be required. This adaptive approach ensures efficient power usage while maintaining optimal AR display readability across various lighting environments. Embodiments of the computing unit 30 can use predefined thresholds to detect these changes, but these can be user-defined or further fine-tuned based on specific application needs.

In response to determining a meaningful increase in intensity, in action 74, the computing unit 30 can activate one or more ultraviolet sources 26 to adjust one or more attributes of the photo-reactive coating 18 in order to enhance a contrast of the AR content being presented to the user 2. In embodiments, the ultraviolet source(s) 26 can be operated in a pulsed mode, in which the ultraviolet source(s) 26 are periodically turned on and off to maintain the adjusted attribute(s) of the photo-reactive coating 18 while the ambient light intensity remains high. In embodiments, the computing unit 30 can select one or more periods for the pulsed mode based on the intensity. To this extent, the computing unit 30 can gradually increase a dose (e.g., by reducing the period in which the ultraviolet source(s) 26 are off and/or increasing a period for which the ultraviolet source(s) 26 are on) delivered to the photo-reactive coating 18 based on an increasing intensity.

In response to determining a meaningful decrease in intensity, in action 76, the computing unit 30 can deactivate the one or more ultraviolet sources 26. In this case, the attribute(s) of the photo-reactive coating 18 will return to a default state over time. In embodiments, the computing unit 30 can gradually decrease a dose (e.g., by increasing the period in which the ultraviolet source(s) 26 are off and/or decreasing a period for which the ultraviolet source(s) 26 are on) delivered to the photo-reactive coating 18 based on a decreasing intensity. As illustrated, the process can be continuously repeated while AR content is being presented to the user 2 on the AR display.

As described herein, in embodiments, the computing unit 30 can operate the ultraviolet sources 26 to provide a desired dose of ultraviolet radiation present in the ambient environment. To this extent, embodiments can include one or more sensing devices 24 configured to acquire data regarding an amount of ultraviolet light present in the ambient light. The ultraviolet light data can correspond to the type of ultraviolet light (e.g., UV-A, UV-B, and/or UV-C) required to activate the photo-reactive coating 18 and can be used to determine a dose of ultraviolet light being provided by the ambient lighting. Data from such a sensing device 24 can be used to operate differently in a bright environment created by artificial light, where little or no ultraviolet light may be present, and a bright environment created by sunlight, in which ultraviolet light may already be present. In each case, the computing unit 30 can adjust a dose provided by the ultraviolet sources 26 in order to provide the desired dose of ultraviolet radiation to the photo-reactive coating 18.

As used herein, unless otherwise noted, the term “set” means one or more (i.e., at least one) and the phrase “any solution” means any now known or later developed solution. The singular forms “a,” “an,” and “the” include the plural forms as well, unless the context clearly indicates otherwise. Additionally, the terms “comprises,” “includes,” “has,” and related forms of each, when used in this specification, specify the presence of stated features, but do not preclude the presence or addition of one or more other features and/or groups thereof.

As also used herein, a layer is a transparent layer when the layer allows at least ten percent of radiation having a target wavelength, which is radiated at a normal incidence to an interface of the layer, to pass there through. Furthermore, as used herein, a layer is a reflective layer when the layer reflects at least ten percent of radiation having a target wavelength, which is radiated at a normal incidence to an interface of the layer. In an embodiment, the target wavelength of the radiation corresponds to a wavelength of radiation emitted or sensed (e.g., peak wavelength +/−five nanometers) by an active region of an optoelectronic device during operation of the device. For a given layer, the wavelength can be measured in a material of consideration and can depend on a refractive index of the material.

It is understood that, unless otherwise specified, each value is approximate and each range of values included herein is inclusive of the end values defining the range. Terms of degree such as “generally,” “substantially,” “about,” and “approximately” as used herein mean a reasonable amount of deviation of the modified term such that the end result is not significantly changed. For example, these terms can be construed as including a deviation of at least +/−0.5% of the modified term if this deviation would not negate the meaning of the word it modifies. In a more particular example, the term “approximately” is inclusive of values within +/−ten percent of the stated value, while the term “substantially” is inclusive of values within +/−five percent of the stated value when these deviations would not negate the meaning of the word each term modifies. Unless otherwise stated, two values are “similar” when the amount of deviation between the two values does not significantly change the result. In a more particular example, two values are similar when the smaller value is within +/−twenty-five percent of the larger value. A value, y, is on the order of a stated value, x, when the value y satisfies the formula 0.1x≤y≤10x.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. An augmented reality system comprising:
a display substrate including:
a transparent substrate; and
a photo-reactive coating applied to at least a portion of a surface of the transparent substrate, wherein the at least the portion of the surface corresponds to an area on which augmented reality content can be displayed during use of the augmented reality system.

2. The augmented reality system of claim 1, further comprising:
a frame securing the display substrate; and
at least one ultraviolet light source configured to emit ultraviolet radiation directed onto a region of the photo-reactive coating from at least one location on the frame.

3. The augmented reality system of claim 2, further comprising:
at least one light sensor configured to acquire ambient lighting data regarding ambient lighting for an environment in which the display substrate is located; and
a control unit configured to operate the at least one ultraviolet light source based on the ambient lighting data.

4. The augmented reality system of claim 3, wherein the control unit is configured to operate the at least one ultraviolet light source to selectively emit ultraviolet radiation onto at least one region of the photo-reactive coating from a subset of a plurality of locations on the frame based on a location of augmented reality content being displayed on the display substrate.

5. A wearable device comprising the augmented reality system of claim 3.

6. The wearable device of claim 5, wherein the photo-reactive coating is located on a side of the display substrate located furthest from a user when the wearable device is properly worn.

7. The wearable device of claim 5, wherein the ambient lighting data includes an intensity of visible light and/or an intensity of ultraviolet light.

8. The wearable device of claim 5, wherein the ambient lighting data includes both an intensity of visible light and an intensity of ultraviolet light, and wherein the control unit is configured to individually operate at least one of the plurality of ultraviolet light sources in response to the intensity of visible light exceeding a visible light predetermined value and the intensity of ultraviolet light being less than an ultraviolet light predetermined value.

9. A vehicle comprising the augmented reality system of claim 1, wherein the display substrate is at least one of: a windshield, a window, or a mirror, of the vehicle.

10. A wearable device comprising:
an augmented reality control system configured to present augmented reality content to a user wearing the wearable device; and
a transparent display substrate including:
a transparent substrate through which the user can view an environment and on which augmented reality content can be displayed; and
a photo-reactive coating applied to only a portion of an outer facing surface of the transparent substrate, wherein the portion of the outer facing surface corresponds to an area of the transparent substrate on which the augmented reality content can be displayed.

11. The wearable device of claim 10, further comprising:
a frame securing the display substrate; and
at least one ultraviolet light source configured to emit ultraviolet radiation directed onto a region of the photo-reactive coating from at least one location on an outer facing side of the frame.

12. The wearable device of claim 11, further comprising at least one light sensor mounted on the frame, the at least one light sensor configured to acquire ambient lighting data regarding ambient lighting for an environment in which the display substrate is located, wherein the augmented reality control system is configured to operate the at least one ultraviolet light source based on the ambient lighting data.

13. The wearable device of claim 12, wherein the ambient lighting data includes both an intensity of visible light and an intensity of ultraviolet light, and wherein the augmented reality control system is configured to operate the at least one ultraviolet light source in response to the intensity of visible light exceeding a visible light predetermined value and the intensity of ultraviolet light being less than an ultraviolet light predetermined value.

14. The wearable device of claim 11, wherein the at least one ultraviolet light source is configured to emit ultraviolet radiation directed onto a plurality of distinct regions of the photo-reactive coating from a plurality of locations, wherein the augmented reality control system is configured to selectively illuminate only a subset of the plurality of distinct regions corresponding to augmented reality content being displayed.

15. An augmented reality system comprising:
an augmented reality control system configured to present augmented reality content to a user;
a display substrate including:
a transparent substrate; and
a photo-reactive coating applied to at least a portion of a surface of the transparent substrate, wherein the at least the portion of the surface corresponds to an area on which augmented reality content can be displayed during use of the augmented reality system;
at least one light sensor configured to acquire ambient lighting data regarding ambient lighting for an environment in which the display substrate is located; and
at least one ultraviolet light source configured to emit ultraviolet radiation directed onto at least one region of the photo-reactive coating from at least one location on the frame based on the ambient lighting data.

16. The augmented reality system of claim 15, wherein the ambient lighting data includes both an intensity of visible light and an intensity of ultraviolet light, and wherein the augmented reality control system is configured to individually operate the at least one ultraviolet light source in response to the intensity of visible light exceeding a visible light predetermined value and the intensity of ultraviolet light being less than an ultraviolet light predetermined value.

17. The augmented reality system of claim 15, wherein the user views an environment through the transparent substrate, and wherein the photo-reactive coating is applied to a surface of the transparent substrate configured to be furthest from the user when using the augmented reality system.

18. The augmented reality system of claim 15, wherein the at least one ultraviolet light source is configured to emit ultraviolet radiation directed onto a plurality of distinct regions of the photo-reactive coating from a plurality of locations, wherein the augmented reality control system is configured to selectively illuminate only a subset of the plurality of distinct regions corresponding to augmented reality content being displayed.

19. A wearable device comprising the augmented reality system of claim 15.

20. The wearable device of claim 19, further comprising a structure configured to hold the display substrate in front of a user's eyes.
